(19) United States
(12) Patent Application Publication
(10) Pub. No.: US 2023/0169574 A1
(43) Pub. Date: Jun. 1, 2023

(54) OMNI-CHANNEL DINING EXPERIENCES

(71) Applicant: Capital One Services, LLC, McLean, VA (US)

(72) Inventors: Lin Ni Lisa Cheng, New York, NY (US); Rocky Guo, Vienna, VA (US); Xiaoguang Zhu, New York, NY (US)

(21) Appl. No.: 17/538,794

(22) Filed: Nov. 30, 2021

(51) Int. Cl. G06Q 30/06

(52) U.S. Cl. CPC G06Q 30/0633

(57) ABSTRACT

The innovation disclosed and claimed herein, in one aspect thereof, comprises systems and methods of omni-channel dining experiences. The innovation receives a customer request from a customer to recreate at home a menu item from a restaurant. Restaurant data and a transaction history of the customer can be retrieved and analyzed to determine a recipe for the restaurant dish and a restaurant scene for recreating the dining experience of the restaurant. A set of ingredients based on the determined recipe is automatically ordered. The set of ingredients can be altered based on a number of people in the customer request. Multimedia instructions can be presented to the customer to follow the recipe to recreate the restaurant dish. A restaurant scene is generated and presented via a multimedia system. The restaurant scene can be a view or ambiance the recreates the experience of the restaurant within the customer's home.

### BACKGROUND

Restaurant dining is a unique experience. However, in recent times, customers are increasingly dining at home. Customers are finding it more and more difficult to capture such an experience while dining at home. It is difficult to recreate restaurant dishes at home. Customers usually do not have the instruction, knowledge, ingredients, recipes, and/or the like to recreate the restaurant dining experience. Further, it is impossible to recreate the ambiance of a restaurant at home. A customer's home usually cannot provide the ambiance of other diners, sounds, sights, smells, and/or the like that a restaurant provides.

### BRIEF SUMMARY OF THE DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of omni-channel dining experiences. The innovation receives a customer request from a customer to recreate a menu item at home from a restaurant. Restaurant data and a transaction history of the customer can be retrieved and analyzed to determine a recipe for the restaurant dish and a restaurant scene for recreating the dining experience of the restaurant. A set of ingredients based on the determined recipe is automatically ordered. The set of ingredients can be altered based on a number of people in the customer request. Multimedia instructions can be presented to the customer to follow the recipe to recreate the restaurant dish. A restaurant scene is generated and presented via a multimedia system. The restaurant scene can be a view or ambiance the recreates the experience of the restaurant within the customer's home.

In aspects, the subject innovation provides substantial benefits in terms of at home dining experience. One advantage resides in a recreation of a restaurant experience. Another advantage resides in a seamless experience recreation based on customer transaction history.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates a high level diagram of the subject innovation.

FIG. 2 illustrates an example component diagram of an experience engine.

FIG. 3 illustrates an example component diagram of an analysis component.

FIG. 4 illustrates an example component diagram of a presentation component.

FIG. 5 illustrates a method for an omni-channel dining experience.

FIG. 6 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

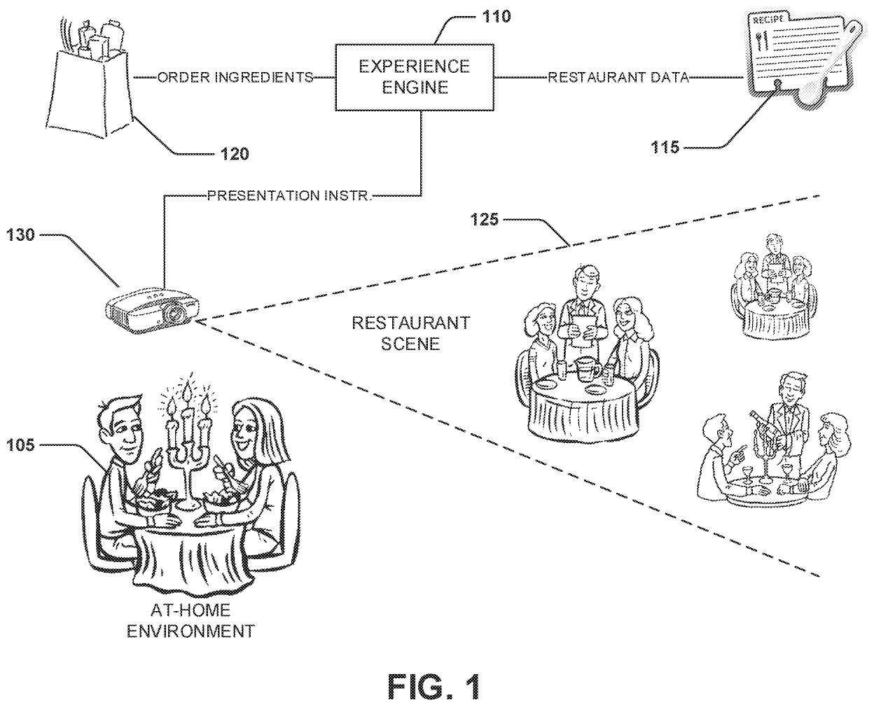

FIG. 1 illustrates a high level view of the subject innovation. A customer 105 can submit a request to an experience engine 110 for recreating a restaurant experience. The request can include a restaurant dish or menu item, a full meal, an ambiance, a listed restaurant, a date, a time, a location, allergies, guest list, amount of guests, contact information, and/or the like. The customer can submit the request via a user device (not shown) such as a personal computer, mobile smart phone, application, internet of things device, user interface, wearable device, and/or the like. The experience engine 110 can receive the request from the customer 105 via the user device over a network, mobile network, and/or other communication protocol.

The experience engine 110 analyzes the transaction history of the customer and restaurant data from data sources. The experience engine 110 retrieve restaurant data from the data sources. The data sources can include restaurant information, menus, transaction history of the customer, recipe data, chef information, image data, review data, and/or the like. The data sources can be accessed electronically over a network. The experience engine 110 can seek out the data sources for data that facilitates fulfilling the request. For example, the experience engine 110 can interrogate a customer transaction history to determine which menu items the customer 105 has purchased from a restaurant and match the menu items to the request.

The experience engine 110 determines a recipe 115 of the restaurant dish or menu item to fulfill the request. The experience engine determines the recipe 115 for the restaurant dish based on the analysis. The recipe 115 includes a set of ingredients and/or instructions for recreating the restaurant dish or menu item. The experience engine 110 can analyze reviews, social media posts, image data, and/or the like to confirm or alter the recipe 115. For example, the customer 105 wants to recreate a chicken parmesan dish from a new Italian restaurant. The experience engine 110 can use the data sources to determine a chicken parmesan recipe similar to the restaurant's menu description and ingredient list. The experience engine 110 can further look at photos posted of the chicken parmesan and tagged with the restaurant to further develop the recipe 115 for special ingredients and/or instructions for recreating the dish. In some embodiments, the experience engine 110 and the restaurant can reach an agreement such that the restaurant can provide specific recipes to the experience engine 110.

The experience engine 110 can interface a grocery service to order the set of ingredients included in the recipe 115. From the recipe, the experience engine 110 can adapt the recipe 115 for the amount of people and automatically adjust the amount of each ingredients in the set of ingredients. In some embodiments, the experience engine 110 can adjust the recipe 115 according to allergy restrictions, dietary restrictions, customer preferences, and/or the like. The experience engine 110 can automatically place an order with a grocery service and/or the like for delivery or pickup before the date and/or time in the request. The experience engine 110 can include an alert structure to alert the customer 105 regarding the ingredients order.

The experience engine 110 can provide instructions to the customer 115 for recreating the restaurant dish or menu item. In some embodiments, the instructions are written instructions that are sent or otherwise provided to the customer 105. The instructions can be via email, text message, website, application, and/or the like. The instructions can be presented via the user device. In some embodiments, the instructions can include plating instructions, ambiance instructions, decoration instructions, and/or the like for the recipe 115.

In some embodiments, the experience engine 110 can generate multimedia instructions for the recipe 115. The multimedia instructions can be interactive, video, audio, Graphics Interchange Format GIF, animated, and/or the like. The experience engine 110 can utilize deep learning and/or machine learning for generating the multimedia instructions. In other embodiments, the experience engine 110 can partner with chefs and/or restaurants to provide multimedia instructions for recreating the recipes 115. In yet another embodiment, the experience engine 110 can include a platform to connect the customer 105 to a private chef that can cook the recipe 115 at the customer's 105 home or deliver a finished meal to the customer's 105 home. In some embodiments, the private chef is affiliated with the restaurant that is partnered with the experience engine 110.

The experience engine 110 generates and presents a restaurant experience based on the data analysis. The experience engine 110 can generate and present a restaurant scene 125. The restaurant scene 125 is a view of the restaurant or recreation of a restaurant scene that be presented to the customer 105 and/or guests while the menu item is being prepared and/or eaten. In some embodiments, the restaurant scene 125 is a recorded or live video capture of a dining room of the restaurant that is being recreated. In other embodiments, the restaurant scene 125 is a virtual scene, an animated scene, a prerecorded scene, a live scene, and/or the like. The restaurant scene 125 can depict diners, waiters, bartenders, chairs, tables, bars, a unique view of the restaurant, and/or the like.

The experience engine 110 generates the restaurant scene 125 by analyzing the restaurant data from the data sources. The experience engine 110 can analyze image, audio, and/or video data of the restaurant to generate a restaurant scene 125 that is accurate. In some embodiments, the experience engine 110 can capture a soundtrack of music and/or sounds of the restaurant to generate and present to the customer 105. In some embodiments, the experience engine 110 factors in time and date of the meal in the request for generating the restaurant scene.

The experience engine 110 can present the restaurant scene 125 via a scene rendering device 130. The scene rendering device 130 can be a projector, a television, a virtual reality device, an augmented reality device, a holographic device, an olfactory device, and/or the like. The scene rendering device 130 an provide sights, sounds, and/or smells to be enjoyed by the customer 105 during the meal.

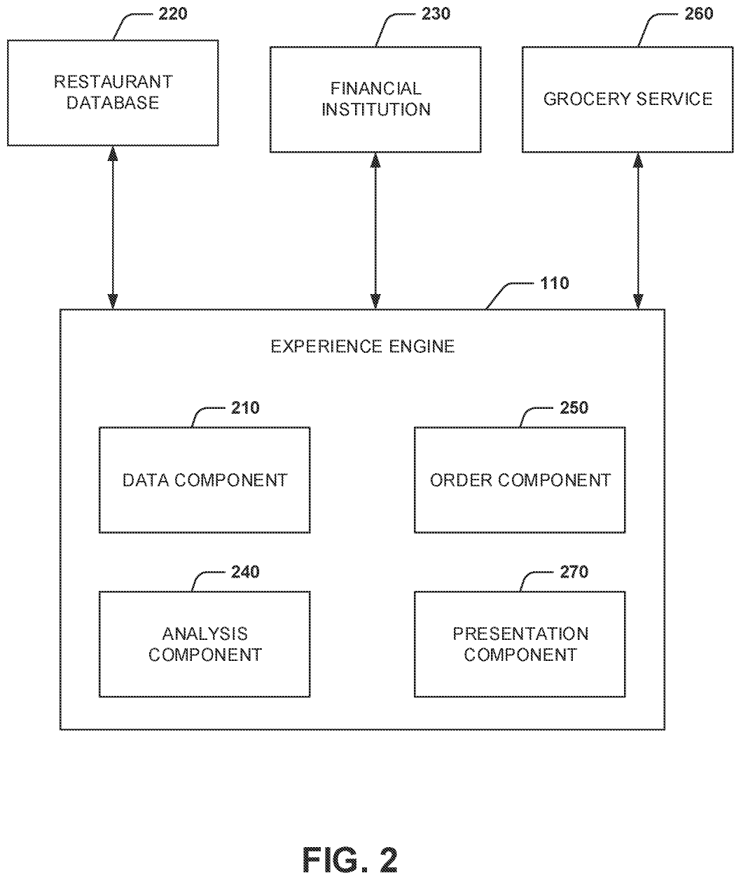

FIG. 2 illustrates a detailed component diagram of the experience engine 110. The experience engine 110 includes a data component 210. The data component 210 can receive a request to recreate a restaurant experience from a customer 105. The request can include a restaurant dish or menu item, a full meal, an ambiance, a listed restaurant, a date, a time, a location, allergies, guest list, amount of guests, contact information, and/or the like. The customer 105 can submit the request via a user device (not shown) such as a personal computer, mobile smart phone, application, internet of things device, user interface, wearable device, and/or the like. The data component 210 can receive the request from the customer 105 via the user device over a network, mobile network, and/or other communication protocol.

The data component 210 retrieves restaurant data from a restaurant database 220. The restaurant database 220 can include restaurant information, menus, transaction history of the customer, recipe data, chef information, image data, review data, and/or the like. The restaurant database 220 can be accessed automatically over a network. The data component 210 can seek out the data in the restaurant database 220 that facilitates fulfilling the request.

The data component 210 also retrieves data from a financial institution 230. The financial institution 230 can include customer information such as customer transaction history, spending habits, financial accounts, and/or the like. For example, the data component 210 can retrieve a customer transaction history from the financial institution 230 to determine which menu items the customer 105 has purchased from a restaurant and match the menu items to the request. In another example, the data component 210 can retrieve customer spending habits to determine types of restaurant experiences that the customer 105 typically enjoys. For example, a customer usually buys pho from a Vietnamese restaurant. The data component 230 can assume that pho is the menu item associated with a transaction at the Vietnamese restaurant.

In some embodiments, the data component 210 can collect restaurant data via a sensor located in the restaurant. The sensor may be a device of a patron or someone affiliated with the restaurant. The sensor can capture image data, audio data, temperature, humidity, noise level, light level, natural light level, artificial light level, and/or the like. The sensor can collect the data and provide the data to the restaurant database 220. The data component 210 can factor in the sensor data for recreating the restaurant experience.

The experience engine 110 includes an analysis component 240. The analysis component 240 analyzes the transaction history of the customer from the financial institution 230 and restaurant data from the restaurant database 220. The analysis component 240 determines a recipe 115 of the restaurant dish or menu item to fulfill the request. The analysis component 240 determines the recipe 115 for the restaurant dish based on the analysis that includes a set of ingredients and/or instructions for recreating the restaurant dish or menu item.

The analysis component 240 can analyze reviews, social media posts, image data, and/or the like to confirm or alter the recipe 115. For example, the customer 115 wants to recreate a pho dish from a new Vietnamese restaurant. The analysis component 240 can use the data sources to determine a pho recipe similar to the restaurant's menu description and ingredient list. The analysis component 240 can further look at photos posted of the pho and tagged with the restaurant to further develop the recipe 115 for special ingredients and/or instructions for recreating the dish. In some embodiments, the analysis component 240 utilizes image matching algorithms, machine learning, deep learning, natural language processing, and/or the like to determine the recipe 115, set of ingredients, instructions, and/or the like. In other embodiments, the analysis component 240 can use reviews for any mention of special ingredients and/or the like.

The experience engine 110 includes an order component 250. The order component 250 can interface with a grocery service 260 to order the set of ingredients included in the recipe 115. From the recipe, the order component 250 can adapt the recipe 115 for the amount of people and automatically adjust the amount of each ingredients in the set of ingredients. In some embodiments, the order component 250 can adjust the recipe 115 according to allergy restrictions, dietary restrictions, customer preferences, and/or the like. The order component 250 can automatically place an order with a grocery service and/or the like for delivery or pickup before the date and/or time in the request. In some embodiments, the order component 250 can utilize the customer's 105 financial information from the financial institution 230 to supply payment information to the grocery service 260 for the set of ingredients. In other embodiments, the order component 250 can retrieve an account from the financial institution 230 that is associated with the grocery service 260. The grocery service 260 receives the order and coordinates shopping and delivery of the set of ingredients to the customer 105 or cooking location.

The analysis component 240 can provide instructions to the customer 115 for recreating the restaurant dish or menu item. In some embodiments, the instructions are written instructions that are sent or otherwise provided to the customer 105. The instructions can be via email, text message, website, application, and/or the like. The instructions can be presented via the user device. In some embodiments, the instructions can include plating instructions, ambiance instructions, decoration instructions, and/or the like for the recipe 115.

The experience engine 110 includes a presentation component 270. The presentation component 270 can generate multimedia instructions for the recipe 115. The multimedia instructions can be interactive, video, audio, GIF, animated, and/or the like. The presentation component 270 can utilize deep learning and/or machine learning for generating the multimedia instructions. In other embodiments, the presentation component 270 can partner with chefs and/or restaurants to provide multimedia instructions for recreating the recipes. In yet another embodiment, the presentation component 270 can include a platform to connect the customer 105 to a private chef that can cook the recipe 115 at the customer's 105 home or deliver a finished meal to the customer's 105 home. In some embodiments, the private chef is affiliated with the restaurant that is partnered with the presentation component 270.

The presentation component 270 generates and presents a restaurant experience based on the data analysis. The presentation component 270 can generate and present a restaurant scene 125. The restaurant scene 125 is a view of the restaurant or recreation of a restaurant scene that be presented to the customer 105 and/or guests while the meal is being prepared and/or eaten. In some embodiments, the restaurant scene 125 is a recorded or live video capture of a dining room of the restaurant that is being recreated. In other embodiments, the restaurant scene 125 is a virtual scene, an animated scene, a prerecorded scene, a live scene, and/or the like.

The presentation component 270 generates the restaurant scene 125 by analyzing the restaurant data from the data sources. The presentation component 270 can analyze image, audio, and/or video data of the restaurant to generate a restaurant scene 125 that is accurate. In some embodiments, the presentation component 270 can capture a soundtrack of music and/or sounds of the restaurant to generate and present to the customer 105. In some embodiments, the presentation component 270 factors in time and date of the meal in the request for generating the restaurant scene. In some embodiments, the presentation component 270 can integrate with a home automation system associated with the customer's home. The presentation component 270 can alter lighting, temperature, humidity, other smart-home features, and/or the like according to the restaurant data to recreate the restaurant experience for the restaurant scene 125.

The presentation component 270 can present the restaurant scene 125 via a scene rendering device 130. The scene rendering device 130 can be a projector, a television, a virtual reality device, an augmented reality device, a holographic device, an olfactory device, and/or the like. The scene rendering device 130 can provide sights, sounds, and/or smells to be enjoyed by the customer 105 during the meal.

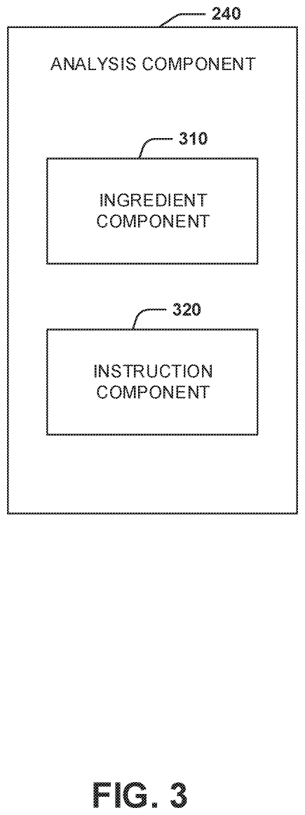

FIG. 3 illustrates a component diagram of the analysis component 240. The analysis component 240 an ingredient component 310. The ingredient component 310 analyzes the transaction history of the customer from the financial institution 230 and restaurant data from the restaurant database 220. The ingredient component 310 determines the set of ingredients of the restaurant dish or menu item to fulfill the request. The ingredient component 310 determines the set of ingredients for the restaurant dish based on the analysis. In some embodiments, the ingredient component 310 uses natural language processing of a description of the menu item to determine the set of ingredients. For example, a tuna dish is described on the restaurant menu as including soy sauce, ginger, and lime juice. The ingredient component 310 can use the natural language processing to ensure that those ingredients are in the recipe. The ingredient component 310 can further use natural language processing on reviews of the menu item. For example, a review can state that the tuna dish had a “hint of garlic flavor.” The ingredient component 310 can ensure that a small amount of garlic is included in the set of ingredients.

The analysis component 240 includes an instruction component 320. The instruction component 320 can provide instructions to the customer 105 for recreating the restaurant dish or menu item. In some embodiments, the instructions are written instructions that are sent or otherwise provided to the customer 105. The instructions can be via email, text message, website, application, and/or the like. The instructions can be presented via the user device. In some embodiments, the instructions can include plating instructions, ambiance instructions, decoration instructions, and/or the like for the recipe 115. In some embodiments, the instruction component 320 can determine a skill level of the customer 105 or person who will be cooking the menu item. The instruction component 320 can factor in the skill level to correspond to type and/or depth of instruction for the instructions to be provided. For example, the instruction component 320 can determine a skill level of a customer 105 based on social media posts of finished cooking projects. The instruction component 320 can determine the customer 105 is a novice chef due to only posting a handful of cooking projects over a longer period of time. The instruction component 320 can provide more detailed instructions such as video instructions for recreating the menu item. In some embodiments, the instruction component 320 can detect motion of the customer 105 or preparer of the meal to determine how well the preparation of the meal is and provide live feedback to the customer 105. In some embodiments, the instructions are live video with a chef that can provide live feedback to the customer 105.

In some embodiments, the ingredient component 310 and/or the instruction component 320 can analyze reviews, social media posts, image data, and/or the like to confirm or alter the set of ingredients and/or instructions. For example, the customer 115 wants to recreate a curry dish from an Indian restaurant. The instruction component 320 can use the data sources to determine steps typically used to cook a curry recipe similar to the restaurant's menu description and ingredient list. The instruction component 320 can further look at photos posted of the curry and tagged with the Indian restaurant to further develop the set of ingredients for special ingredients and/or instructions for recreating the dish. In some embodiments, the ingredient component 310 and/or the instruction component 320 utilizes image matching algorithms, machine learning, deep learning, natural language processing, and/or the like to determine the recipe 115, set of ingredients, instructions, and/or the like. In other embodiments, the ingredient component 310 and/or the instruction component 320 can analyze video recipes to determine special ingredients or unique cooking techniques utilized to prepare the curry. The video recipe can be associated with the chef of the restaurant, a chef that is followed by the customer 105, and/or the like.

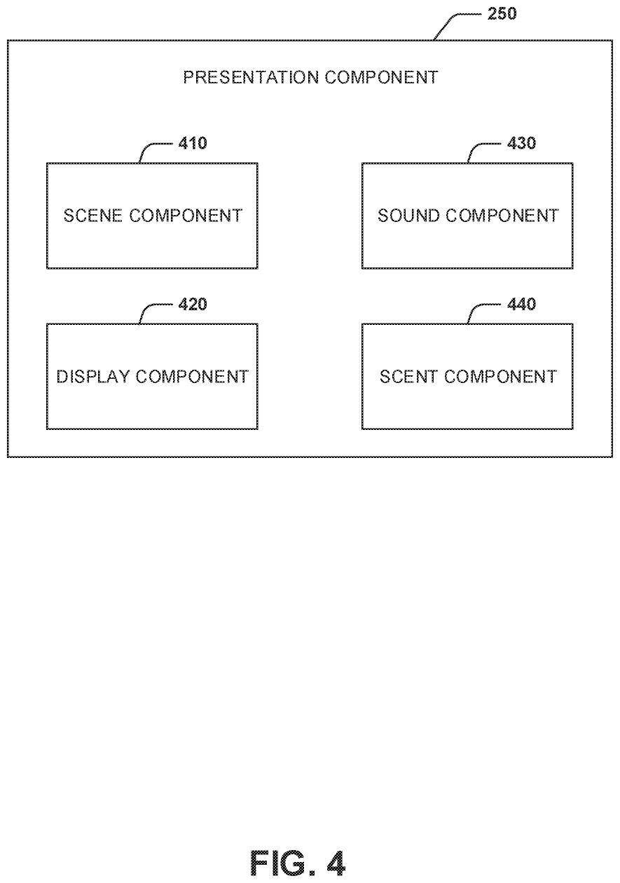

FIG. 4 illustrates a component diagram of the presentation component 270. The presentation component 270 includes a scene component 410. The scene component 410 can present multimedia instructions for the recipe 115 via a display component 420. The multimedia instructions can be interactive, video, audio, GIF, animated, and/or the like. The scene component 410 can utilize deep learning and/or machine learning for generating the multimedia instructions. In other embodiments, the scene component 410 can partner with chefs and/or restaurants to provide multimedia instructions for recreating the recipes.

The scene component 410 generates a restaurant experience based on the data analysis. The scene component 410 can generate the restaurant scene 125. The restaurant scene 125 is a view of the restaurant or recreation of a restaurant scene that be presented to the customer 105 and/or guests while the meal is being prepared and/or eaten. In some embodiments, the restaurant scene 125 is a recorded or live video capture of a dining room of the restaurant that is being recreated. In other embodiments, the restaurant scene 125 is a virtual scene, an animated scene, a prerecorded scene, a live scene, and/or the like.

The scene component 410 generates the restaurant scene 125 by analyzing the restaurant data from the data sources. The scene component 410 can analyze image, audio, and/or video data of the restaurant to generate a restaurant scene 125 that is accurate. In some embodiments, the scene component 410 can capture a soundtrack of music and/or sounds of the restaurant to generate and present to the customer 105. In other embodiments, the scene component 410 can integrate with a music streaming service that the restaurant also subscribes. The scene component 410 can match playlists of the restaurant or automatically generate a playlist based on the restaurant profile on the music streaming service. In some embodiments, the scene component 410 factors in time and date of the meal in the request for generating the restaurant scene. The scene component 410 can generate a real life view, an animated view, and/or the like of the restaurant scene 125.

The display component 420 can present the restaurant scene 125. The display component 420 can be a projector, a television, a virtual reality device, an augmented reality device, a holographic device, and/or the like. For example, the display component 420 presents the restaurant scene on the customer's 105 television or the customer's 105 projector and screen. In some embodiments, the display component 420 can present an augmented reality view. The augmented reality view can be a restaurant scene that is overlaid on a real world view as viewed by the customer 105 and/or other meal participants. The augmented reality view can combine the overlaid restaurant scene and the real world view and presented via the display component 420 such as a wearable device and/or the like. In some embodiments, the display component 420 can present a virtual reality view. The virtual reality view can be presented via a wearable device and/or the like such that the customer 105 is immersed in the view and can move about a three-dimensional virtual reality version of the restaurant scene.

In some embodiments, the display component 420 can present a holographic view. The holographic view can be presented via a holographic generator such that holographic images of the restaurant scene appear in the space where the customer 105 is dining. For example, a hologram of a couple of people having drinks at a bar can appear in the customer's 105 home or bar area of the customer's 105 home.

The presentation component 250 can include a sound component 430. The sound component 430 can present sounds accustomed to the restaurant to recreate for the restaurant scene. In some embodiments, the sound component 430 factors in time of day, location of the restaurant, and/or the like to provide a sound recreation. For example, the sound component 430 can present urban city sounds representing a restaurant located on a busy city street.

The presentation component 250 can include a scent component 330. The scent component 440 can generate smells to be enjoyed by the customer 105 during the meal. The smells can be that of other dishes at the restaurant and/or other unique smells to the restaurant. In some embodiments, the scent component 440 can factor location of the restaurant into generated smells. For example, the scent component 440 can generate a tropical smell representing a beach side restaurant.

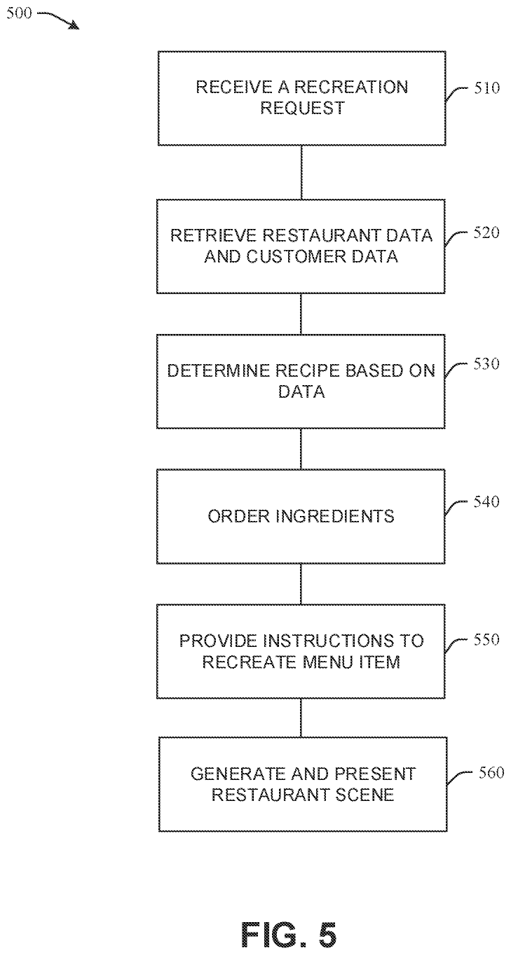

With reference to FIG. 5, example method 500 is depicted for omni-channel dining experiences. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 500 are described in conjunction with a specific example is for explanation purposes.

FIG. 5 illustrates a method 500 for omni-channel dining experiences. At 510, a request to recreate a restaurant experience is received. The request can be made by a customer 105 to an experience engine 110. The request can include information for the experience such as time, date, menu item, allergies, number of guests, restaurant, location, preparer, and/or the like. At 520, restaurant data and customer transaction data are retrieved. The restaurant data can include menu, description, recipes, image data, video data, audio data, temperature data, and/or the like. The customer transaction data can include itemized transactions at the restaurant, data of transaction, location of transaction, and/or the like.

At 530, a recipe is determined based on an analysis of the restaurant data and customer transaction data. The analysis can identify the restaurant, the restaurant menu item, a set of ingredients, instructions to recreate the menu item, and/or the like. At 540, the set of ingredients are ordered. The experience engine 110 can interface with a grocery service 260 to order the set of ingredients for delivery to the customer 105 or preparer of the menu item. At 550, instructions to recreate the menu item are provided. The experience engine 110 can provide multimedia instructions to the customer 105 such as cooking and plating instructions. At 560, a restaurant scene is generated and presented when the customer 105 is ready to consume the menu item. The experience engine 110 can present the restaurant scene via a scene rendering device 130. The restaurant scene can recreate the ambiance of the restaurant as a view of the restaurant scene, lighting, smell, temperature, humidity, and/or the like.

The innovation disclosed and claimed herein, in one aspect thereof, comprises systems and methods of omni-channel dining experiences. A method, comprising: receiving a customer request from a customer to recreate a restaurant dish from a restaurant; analyzing transaction history of the customer and restaurant data in response to the request; and generating and presenting a restaurant experience based on the data analysis.

A system, comprising: one or more processors having instructions, the instructions comprising: receiving a customer request from a customer to recreate a restaurant dish from a restaurant; analyzing transaction history of the customer and restaurant data in response to the request; and generating and presenting a restaurant experience based on the data analysis.

A computer readable medium having instructions to control one or more processors configured to: receive a customer request from a customer to recreate a restaurant dish from a restaurant; analyze restaurant data and a transaction history of the customer; determine a recipe for the restaurant dish based on the data analysis; automatically order a set of ingredients based on the determined recipe, wherein the set of ingredients is based on a number of people in the customer request; generate and provide multimedia instructions to the customer to follow the recipe to recreate the restaurant dish; and generate and present a restaurant scene via a multimedia system based on the data analysis; wherein the multimedia system includes at least one of a display, a projector, an augmented reality device, a virtual reality device, or a holographic device.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

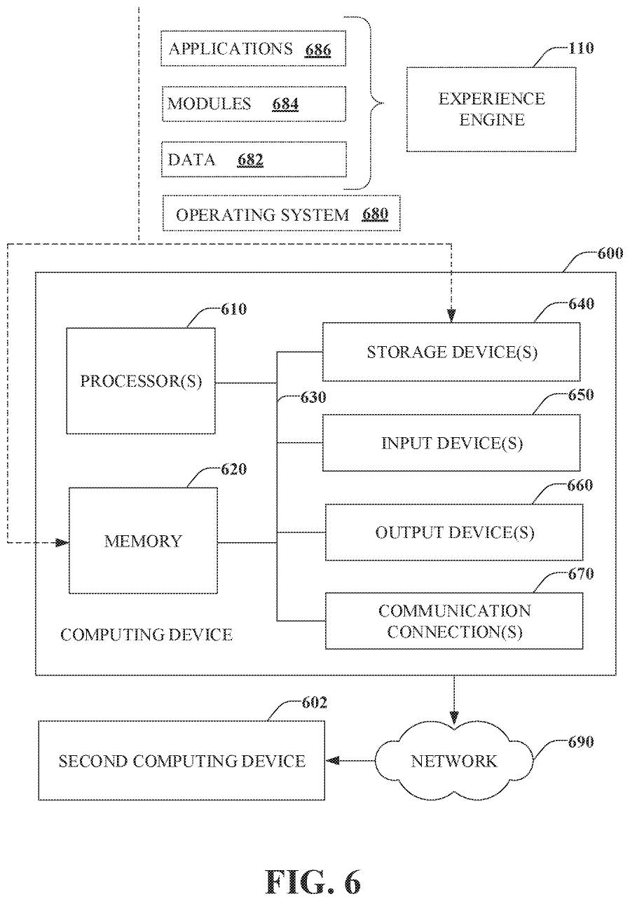

To provide a context for the disclosed subject matter, FIG. 6 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 6, illustrated is an example computing device 600 (e.g., desktop, laptop, tablet, watch, server, hand-held, programmable consumer or industrial electronics, set-top box, game system, compute node . . . ). The computing device 600 includes one or more processor(s) 610, memory 620, system bus 630, storage device(s) 640, input device(s) 650, output device(s) 660, and communications connection(s) 670. The system bus 630 communicatively couples at least the above system constituents. However, the computing device 600, in its simplest form, can include one or more processors 610 coupled to memory 620, wherein the one or more processors 610 execute various computer executable actions, instructions, and or components stored in the memory 620.

The processor(s) 610 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 610 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 610 can be a graphics processor unit (GPU) that performs calculations with respect to digital image processing and computer graphics.

The computing device 600 can include or otherwise interact with a variety of computer-readable media to facilitate control of the computing device to implement one or more aspects of the disclosed subject matter. The computer-readable media can be any available media that accessible to the computing device 600 and includes volatile and nonvolatile media, and removable and non-removable media. Computer-readable media can comprise two distinct and mutually exclusive types, namely storage media and communication media.

Storage media includes volatile and nonvolatile, removable, and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 600. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

The memory 620 and storage device(s) 640 are examples of computer-readable storage media. Depending on the configuration and type of computing device, the memory 620 may be volatile (e.g., random access memory (RAM)), non-volatile (e.g., read only memory (ROM), flash memory . . . ) or some combination of the two. By way of example, the basic input/output system (BIOS), including basic routines to transfer information between elements within the computing device 600, such as during start-up, can be stored in nonvolatile memory, while volatile memory can act as external cache memory to facilitate processing by the processor(s) 610, among other things.

The storage device(s) 640 include removable/non-removable, volatile/non-volatile storage media for storage of vast amounts of data relative to the memory 620. For example, storage device(s) 640 include, but are not limited to, one or more devices such as a magnetic or optical disk drive, floppy disk drive, flash memory, solid-state drive, or memory stick.

Memory 620 and storage device(s) 640 can include, or have stored therein, operating system 680, one or more applications 686, one or more program modules 684, and data 682. The operating system 680 acts to control and allocate resources of the computing device 600. Applications 686 include one or both of system and application software and can exploit management of resources by the operating system 680 through program modules 684 and data 682 stored in the memory 620 and/or storage device(s) 640 to perform one or more actions. Accordingly, applications 686 can turn a general-purpose computer 600 into a specialized machine in accordance with the logic provided thereby.

All or portions of the disclosed subject matter can be implemented using standard programming and/or engineering techniques to produce software, firmware, hardware, or any combination thereof to control the computing device 600 to realize the disclosed functionality. By way of example and not limitation, all or portions of the experience engine 110 can be, or form part of, the application 686, and include one or more modules 684 and data 682 stored in memory and/or storage device(s) 640 whose functionality can be realized when executed by one or more processor(s) 610.

In accordance with one particular embodiment, the processor(s) 610 can correspond to a system on a chip (SOC) or like architecture including, or in other words integrating, both hardware and software on a single integrated circuit substrate. Here, the processor(s) 610 can include one or more processors as well as memory at least similar to the processor(s) 610 and memory 620, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the experience engine 110 and/or functionality associated therewith can be embedded within hardware in a SOC architecture.

The input device(s) 650 and output device(s) 660 can be communicatively coupled to the computing device 600. By way of example, the input device(s) 650 can include a pointing device (e.g., mouse, trackball, stylus, pen, touch pad . . . ), keyboard, joystick, microphone, voice user interface system, camera, motion sensor, and a global positioning satellite (GPS) receiver and transmitter, among other things. The output device(s) 660, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 650 and output device(s) 660 can be connected to the computing device 600 by way of wired connection (e.g., bus), wireless connection (e.g., Wi-Fi, Bluetooth . . . ), or a combination thereof.

The computing device 600 can also include communication connection(s) 670 to enable communication with at least a second computing device 602 by means of a network 690. The communication connection(s) 670 can include wired or wireless communication mechanisms to support network communication. The network 690 can correspond to a local area network (LAN) or a wide area network (WAN) such as the Internet. The second computing device 602 can be another processor-based device with which the computing device 600 can interact. For example, the computing device 600 can correspond to a server that executes functionality of the experience engine 110, and the second computing device 602 can be a user device that communications and interacts with the computing device 600.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
receiving a customer request from a customer to recreate a restaurant dish from a restaurant;
analyzing transaction history of the customer and restaurant data in response to the request; and
generating and presenting a restaurant experience based on the data analysis.

2. The method of claim 1, further comprising:
determining a recipe for the restaurant dish based on the analysis, wherein the recipe includes a set of ingredients.

3. The method of claim 2, further comprising:
automatically ordering a set of ingredients based on the determined recipe.

4. The method of claim 3, further comprising
wherein an amount of the set of ingredients is based on a number of people in the customer request.

5. The method of claim 1, further comprising:
wherein the recipe includes a set of steps for recreating the restaurant dish.

6. The method of claim 5, further comprising
generating and providing multimedia instructions to the customer, wherein the instructions include the set of steps to recreate the restaurant dish.

7. The method of claim 6, further comprising:
wherein the multimedia instructions include instructions for presentation to recreate the restaurant experience.

8. The method of claim 1, further comprising:
determining a restaurant scene based on the analysis of restaurant data, wherein the analysis includes analyzing image search data of the restaurant to generate the restaurant scene.

9. The method of claim 8, further comprising:
presenting the restaurant scene via a scene rendering device to the customer.

10. A system, comprising:
one or more processors having instructions, the instructions comprising:
receiving a customer request from a customer to recreate a restaurant dish from a restaurant;
determining a recipe for the restaurant dish based on a data analysis, wherein the recipe includes a set of ingredients; and
generating and presenting a restaurant scene based on the data analysis.

11. The system of claim 10, the data analysis further comprising:
analyzing transaction history of the customer and restaurant data in response to the request.

12. The system of claim 10, further comprising:
automatically ordering a set of ingredients based on the determined recipe.

13. The system of claim 12, further comprising
wherein an amount of the set of ingredients is based on a number of people in the customer request.

14. The system of claim 10, further comprising:
wherein the recipe includes a set of steps for recreating the restaurant dish.

15. The system of claim 14, further comprising
generating and providing multimedia instructions to the customer, wherein the instructions include the set of steps to recreate the restaurant dish.

16. The system of claim 15, further comprising:
wherein the multimedia instructions include instructions for presentation to recreate the restaurant experience.

17. The system of claim 10, further comprising:
determining a restaurant scene based on data analysis of restaurant data, wherein the analysis includes analyzing image data of the restaurant to generate the restaurant scene.

18. The system of claim 17, further comprising:
presenting the restaurant scene via a scene rendering device to the customer.

19. A computer readable medium having instructions to control one or more processors configured to:
receive a customer request from a customer to recreate a restaurant dish from a restaurant;
analyze restaurant data and a transaction history of the customer;
determine a recipe for the restaurant dish based on the data analysis;
automatically order a set of ingredients based on the determined recipe, wherein the set of ingredients is based on a number of people in the customer request;
generate and provide multimedia instructions to the customer to follow the recipe to recreate the restaurant dish; and
generate and present a restaurant scene via a multimedia system based on the data analysis.

20. The computer readable medium of claim 19, wherein the one or more processors are further configured to:
wherein the multimedia system includes at least one of a display, a projector, an augmented reality device, a virtual reality device, or a holographic device.
